(19) United States
(12) Patent Application Publication
(10) Pub. No.: US 2025/0153587 A1
(43) Pub. Date: May 15, 2025

(54) BATTERY TEMPERATURE ESTIMATION METHOD AND SYSTEM

(71) Applicants: HYUNDAI MOTOR COMPANY, Seoul (KR); KIA CORPORATION, Seoul (KR)

(72) Inventors: Sang Shin Lee, Suwon-si (KR); Man Ju Oh, Yongin-si (KR); Ki Mok Kim, Busan (KR); Uk Il Yang, Yongin-si (KR)

(73) Assignees: HYUNDAI MOTOR COMPANY, Seoul (KR); KIA CORPORATION, Seoul (KR)

(21) Appl. No.: 18/806,009

(22) Filed: Aug. 15, 2024

(30) Foreign Application Priority Data
Nov. 13, 2023 (KR) 10-2023-0156513

(51) Int. Cl. B60L 53/302; B60L 53/68; B60L 58/12; B60L 58/26; B60L 58/27

(52) U.S. Cl. CPC B60L 53/302; B60L 53/68; B60L 58/12; B60L 58/26; B60L 58/27

(57) ABSTRACT

A battery temperature estimation method and system for improving charging efficiency through management of the temperature of a high-voltage battery provided in an electric vehicle during charging of the high-voltage battery is provided. This is achieved by sharing coolant that is either cooled or heated with coolant managed through a battery charging device outside the vehicle for thermal management of the high-voltage battery to the high-voltage battery. Furthermore, the battery temperature estimation method and system estimates a current battery temperature and a future battery temperature based on battery charging device information and vehicle information to optimize a coolant temperature during charging of the vehicle battery using the battery charging device. As a result, charging efficiency and energy efficiency is improved.

### CROSS-REFERENCE TO THE RELATED APPLICATION

This application claims the benefit of and priority to Korean Patent Application No. 10-2023-0156513, filed on Nov. 13, 2023, the disclosure of which is incorporated herein by reference in its entirety.

### BACKGROUND

### Technical Field

The present disclosure relates to a battery temperature estimation method and system for optimizing a battery temperature when a vehicle battery is charged using a battery charging device.

### Description of the Related Art

In light of the ongoing advancements in electric vehicle technology, there's a growing focus on techniques associated with thermal management for high-voltage batteries in electric vehicles. A high-voltage battery, which plays the role of an engine in a conventional internal combustion engine vehicle, is even more temperature-sensitive than the engine. If the high-voltage battery overheats, damage due to deterioration is likely to occur and its power efficiency also significantly decreases. Therefore, to ensure efficient thermal management of the high-voltage battery, electric vehicles are equipped with cooling lines for the high-voltage battery.

Heat is generated not only when driving a vehicle using a high-voltage battery but also when charging the high-voltage battery. In particular, more heat is generated during high-speed charging of the high-voltage battery, which may cause the high-voltage battery to deteriorate or reduce charging efficiency. Additionally, even when the external temperature is very low, charging efficiency may decrease during charging of a high-voltage battery.

The matters described as background technology above are provided only to enhance the understanding of the background of the present disclosure and should not be taken as acknowledgment that they correspond to prior art already known to those having ordinary skill in the art.

### SUMMARY

The present disclosure has been made in view of the above problems. In particular, to manage the thermal conditions of the high-voltage batteries in electric vehicles, the cooling fluid circulated within the high-voltage battery is shared with an external battery charging device located outside the electric vehicles. This allows either cooled or heated cooling fluid to be supplied to the high-voltage battery during charging, thereby enhancing charging efficiency through temperature management of the high-voltage battery during charging.

It is another object of the present disclosure to improve charging efficiency through management of the temperature of the high-voltage battery at the time of charging the high-voltage battery provided in the electric vehicle. This is achieved by sharing coolant that is either heated or cooled with coolant managed through a battery charging device outside the electric vehicle and supplying the coolant to the high-voltage battery of the electric vehicle.

It is another object of the present disclosure to provide a battery temperature estimation method and system for estimating a current battery temperature and a future battery temperature based on information on a battery charging device and vehicle information to optimize the temperature of coolant when a vehicle battery is charged using the battery charging device. As a result, charging efficiency and energy efficiency is improved.

In an aspect of the present disclosure, a battery temperature estimation method estimates a battery temperature based on shared coolant between a vehicle and a battery charging device located outside the vehicle during battery charging. The method includes collecting vehicle information (e.g., an electric vehicle information) including a voltage, a state of charge (SoC), and a target charging current of a battery of the vehicle. The method includes collecting charging device information including a coolant temperature and a charging current in the battery charging device. Additionally, the method includes estimating a battery temperature of the vehicle through machine learning based on the vehicle information and the charging device information.

The estimating of the battery temperature may include collecting information on the vehicle and the battery charging device by communicating with a server (e.g., processor, controller, or the like). The estimating of the battery temperature may include transmitting, by the server, a command signal such that a coolant temperature of the battery charging device is controlled when the battery temperature of the vehicle is estimated by the server.

The collecting of the vehicle information or the collecting of the charging device information may include further collecting information on an outside temperature.

The collecting of the charging device information may include collecting a flow rate of coolant provided to the vehicle, an inlet side coolant temperature, and an outlet side coolant temperature during battery charging.

The estimating of the battery temperature may further include estimating minimum and maximum temperatures of the battery based on the vehicle information and the charging device information.

The method may further include determining a coolant temperature by determining whether to heat or cool the coolant in the battery charging device based on data regarding the minimum and maximum temperatures and SoC of the battery derived in the estimating of the battery temperature.

Determining the coolant temperature may further include storing, in advance, a set flow rate and a set temperature according to determination of heating or cooling of the coolant.

Determining the coolant temperature may further include comparing the maximum temperature of the battery with a pre-stored safe temperature. Additionally, determining the coolant temperature may further include determining whether to heat or cool the coolant when a heating condition is confirmed according to the minimum temperature of the battery and a cooling condition is confirmed according to the maximum temperature of the battery.

Determining the coolant temperature may further include determining to heat the coolant when the maximum temperature of the battery is lower than the pre-stored safe temperature.

Determining the coolant temperature may further include determining to cool the coolant when the maximum temperature of the battery is higher than the pre-stored safe temperature.

Estimating the battery temperature may further include estimating a predicted temperature corresponding to a battery temperature when the SoC is a set SoC based on the vehicle information and the charging device information. Additionally, determining the coolant temperature may further include determining whether the battery is overcooled or overheated by comparing a maximum set temperature when a pre-derived SoC is the set SoC with the predicted temperature.

Determining the coolant temperature may further include: determining that the battery is overcooled when the predicted temperature is lower than the maximum set temperature; and determining to heat the coolant upon determining that the battery is overcooled.

Determining the coolant temperature may further include determining to heat the coolant when the battery is determined to be overcooled and the heating condition is confirmed according to a current minimum battery temperature.

Determining the coolant temperature may further include: comparing the maximum temperature of the battery with the preset safe temperature when a current maximum battery temperature is determined to correspond to the cooling condition when the battery is determined to be overcooled; heating the coolant when the maximum temperature of the battery is lower than the preset safe temperature; and cooling the coolant when the maximum temperature of the battery is higher than the preset safe temperature.

Determining the coolant temperature may further include: determining that the battery is overheated when the predicted temperature is higher than the maximum set temperature; and cooling the coolant upon determining that the battery is overheated.

Determining the coolant temperature may further include determining to heat the coolant when the battery is determined to be overheated and the heating condition is confirmed according to the current minimum battery temperature.

Determining the coolant temperature may further include: checking whether a heat pump or heating is used when the battery is determined to be overheated; comparing the predicted temperature with the preset safe temperature when the heat pump is operated or heating is performed; and determining to heat the coolant when the predicted temperature is lower than the safe temperature.

Determining the coolant temperature may further include determining to cool the coolant when the current battery temperature is higher than the preset safe temperature and the SoC is less than the set SoC.

Determining the coolant temperature may further include cancelling coolant temperature control when the current battery temperature is higher than the preset safe temperature and the SoC is higher than or equal to the set SoC, or when the current battery temperature is close to the preset maximum set temperature.

In accordance with another aspect of the present disclosure, there is provided a method of estimating a battery temperature based on shared coolant between a vehicle and a battery charging device during battery charging. The method includes: collecting vehicle information including a voltage, a state of charge (SoC), and a target charging current of a battery from the vehicle; and collecting charging device information including a coolant temperature and a charging current in the battery charging device. The method further includes: estimating minimum and maximum temperatures of the battery through machine learning based on the vehicle information and the charging device information, and determining whether to heat or cool the coolant in the battery charging device based on data regarding the minimum and maximum temperatures and SoC of the battery.

In accordance with a further aspect of the present disclosure, there is provided a system for estimating a battery temperature. The system includes a vehicle controller provided in the vehicle and configured to collect vehicle information having a voltage, an SoC, and a target charging current of a battery. The system also includes a charging device controller provided in a battery charging device and configured: to collect charging device information including a coolant temperature and a charging current in the battery charging device, to estimate minimum and maximum temperatures of the battery through machine learning based on the vehicle information and the charging device information, and to determine whether to heat or cool coolant based on data regarding the minimum and maximum temperatures and SoC of the battery.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a flowchart of a battery temperature estimation method according to the present disclosure;

FIG. 2 is a configuration diagram of a battery temperature estimation system according to an embodiment of the present disclosure;

FIG. 3 is a circuit diagram of a battery charging device according to an embodiment of the present disclosure;

FIG. 4 is a graph describing a relationship between a current state of charge of a battery and a temperature of the battery according to a battery temperature estimation method of the present disclosure;

FIG. 5 is a graph describing minimum and maximum temperatures of a battery and a state of charge of the battery according to a battery temperature estimation method of the present disclosure;

FIG. 6 is a table describing minimum and maximum temperatures of a battery and a state of charge of the battery according to a battery temperature estimation method of the present disclosure;

FIG. 7 is a graph describing a relationship between a current state of charge of a battery and a temperature of the battery according to a battery temperature estimation method of the present disclosure;

FIG. 8 is a table comparing predicted temperature and maximum set temperature of a battery according to a battery temperature estimation method of the present disclosure;

FIG. 9 is a circuit diagram describing control during overcooling of a battery in a battery temperature estimation system according to an embodiment of the present disclosure;

and

FIG. 10 is a circuit diagram describing control during overcooling of a battery in a battery temperature estimation system according to an embodiment of the present disclosure.

### DETAILED DESCRIPTION

Reference is made in detail to the embodiments of the present disclosure, examples of which are illustrated in the accompanying drawings. Wherever possible, the same reference numbers are used throughout the drawings to refer to the same or like parts.

The suffixes “module” and “unit” of elements herein are used for the convenience of description and thus can be used interchangeably and do not have any distinguishable meanings or functions.

In the following description of the embodiments disclosed in the present specification, a detailed description of known functions and configurations incorporated herein has been omitted when it was determined it may have obscured the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it should be further understood that the terms “comprise” or “include” specify the presence of a stated feature, figure, step, operation, component, part, or combination thereof, but do not preclude the presence or addition of one or more other features, figures, steps, operations, components, or combinations thereof.

A controller may include a communication device that communicates with other controllers or sensors to control functions thereof, a memory that stores an operating system, logic instructions, input/output information, and the like, and one or more processors that perform determination, calculations, and decisions necessary to control the functions.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus

It should be understood that the term “vehicle” or other similar terms as used herein are inclusive of motor vehicles in general. Such motor vehicles may include sport utility vehicles (SUVs), buses, trucks, various commercial vehicles, and the like. Such motor vehicles may also include watercraft having a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, e.g., a vehicle that is both electric-powered and gasoline-powered.

Hereinafter, a battery temperature estimation method and system according to an embodiment of the present disclosure is described with reference to the attached drawings.

The present disclosure is a battery temperature estimation method based on coolant sharing between a vehicle 100 and a battery charging device 200 during battery charging.

In the case of an electric vehicle, a high-voltage battery (hereinafter referred to as a battery) provided in the vehicle is charged using a charger provided outside the vehicle. Reducing the charging time of electric vehicles is a very important commercial feature.

However, at the time of charging a battery, the battery temperature may reach a certain temperature to increase the charging current. When the battery reaches a certain temperature or higher, the temperature increases due to self-heating, and thus battery cooling may be required.

In this way, the temperature of the battery needs to be continuously managed during battery charging, and a large-capacity heater and compressor are required to heat or cool the battery in the vehicle. However, it is not desirable to provide the heater and the compressor in the vehicle in terms of capacity limitations and cost savings. Additionally, when the battery is not being charged, the heater and the compressor mounted in the vehicle act as a heavy load, adversely affecting fuel efficiency.

Accordingly, at the time of charging the battery of the vehicle 100, the battery charging device 200 supplies cooled or heated coolant to the vehicle to improve charging efficiency by increasing the temperature of the battery in case of cold conditions depending on the environments inside and outside the vehicle. After the temperature increases sufficiently, the battery is cooled to prevent the battery temperature from further increasing. Alternatively, in severe heat conditions, the battery is cooled to prevent the battery from overheating. As a result, the charging efficiency is improved and overheating of the battery is prevented.

The present disclosure collects mobility (e.g., vehicle) information and information on the battery charging device at the time of charging a battery to predict a current battery temperature and a future battery temperature. As a result, the temperature of the battery is optimized through temperature management of the coolant supplied to the battery.

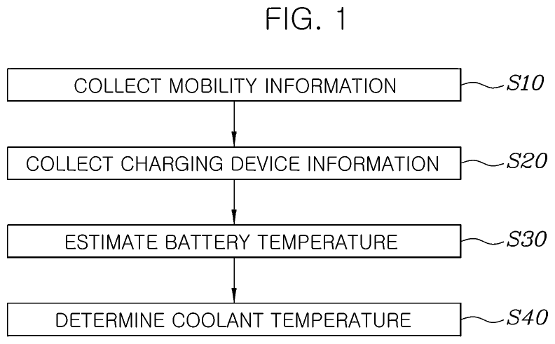

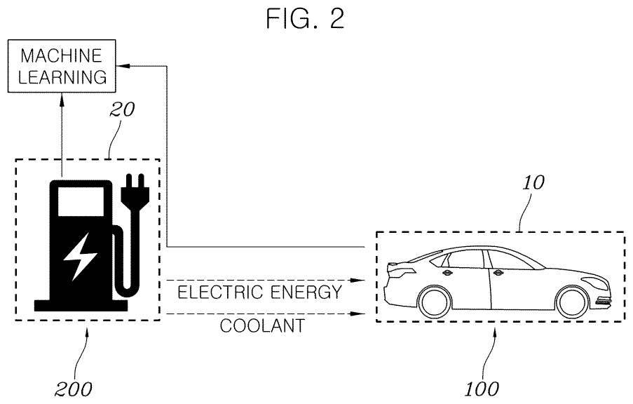

To this end, as shown in FIGS. 1 and 2, a battery temperature estimation method according to the present disclosure includes step S10 of collecting mobility (e.g., vehicle) information such as a battery voltage, a state of charge (SoC), and a target charging current of the battery of the vehicle. The method also includes: at step S20, collecting charging device information including a coolant temperature and a charging current in the battery charging device; and at step S30, estimating a battery temperature of the vehicle based on the vehicle information and charging device information through machine learning.

Vehicle information identified in the vehicle is collected in step S10 of collecting vehicle information, and the vehicle information includes a battery voltage, SoC, and a target charging current. This vehicle information may be collected from a battery power management module, and the SoC of the battery may be ascertained using a charging circuit, voltage regulator, and the like.

In step S20 of collecting charging device information, charging device information identified in the battery charging device is collected. The charging device information includes a coolant temperature and a charging current in the battery charging device. The battery charging device may be an external thermal management station configured to supply battery power and coolant.

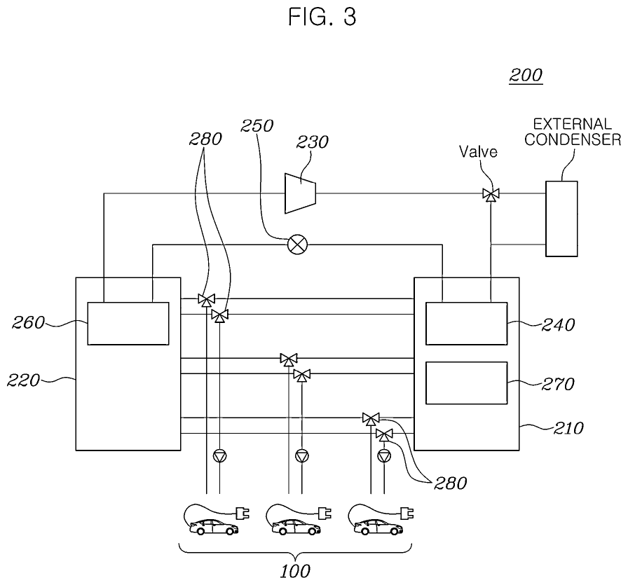

Referring to FIG. 3, the battery charging device 200 includes a first storage tank 210 and a second storage tank 220 in which coolants of different temperatures are managed.

In addition, the battery charging device 200 is configured as a heat management circuit including a heat management compressor 230, a heat management condenser 240, a heat management expander 250, and a heat management evaporator 260 to control the temperature of a refrigerant.

The heat management condenser 240 is provided in the first storage tank 210 such that coolant in the first storage tank 210 can be heated when the heat management condenser 240 generates heat. The heat management evaporator 260 is provided in the second storage tank 220 such that coolant in the second storage tank 220 can be cooled when the heat management evaporator 260 absorbs heat.

In addition, the first storage tank 210 may be further equipped with a heat management heater 270 to provide additional heat when the heat management condenser 240 is insufficient.

Additionally, in the thermal management circuit of the battery charging device 200, valves 280 are applied to lines connected to the vehicle such that the distribution of coolant can be selectively controlled.

In this way, the battery charging device 200 is equipped with a coolant supply system for managing the temperature of the coolant and selectively providing the coolant. As a result, the temperature of the coolant managed by the coolant supply system can be checked.

Additionally, the battery charging device 200 may be equipped with a charging system for power supply management, and the amount of current provided to the vehicle electrically connected to the charging system can be ascertained through the charging system.

In particular, the present disclosure estimates a battery temperature of the vehicle through machine learning based on vehicle information and charging device information.

As a machine learning technique, deep learning using a highly complex neural network structure, such as an artificial neural network, may be used.

For such machine learning, Random Forest, deep neural networks (DNNs), and Long Short Term Memory (LSTM) may be used, and various deep learning algorithms such as convolutional deep neural networks (CNNs) and recurrent Boltzmann machine (RBN) may be utilized.

As an example of machine learning described above, Random Forest is a method of separating input characteristics into decision trees when the characteristics are input and performing prediction by averaging values of different decision trees.

Deep neural network learning is a method of repeatedly inputting training data to a neural network, and calculating errors between outputs of the neural network and targets for the training data. The method also includes backpropagating the errors of the neural network from an output layer of the neural network to an input layer in order to reduce the errors to update the weight of each node in the neural network.

LSTM is a method of erasing unnecessary memories by adding input gates, forget gates, and output gates to memory cells of a hidden layer. The method also includes determining what needs to be memorized, and deriving data values that have passed through a function of each gate using deletion gates, input gates, and output gates in order to obtain values of a hidden state and a cell state. This is used when analyzing values that change over time and is suitable for predicting a system in which a history of changes in previous values affects future values.

As described above, the present disclosure can utilize various machine learning methods in addition to deep learning described above. The present disclosure can also improve the accuracy of battery temperature estimation by collecting multiple machine learning methods or setting the priority of each machine learning method.

In other words, the present disclosure derives a battery temperature by applying vehicle information such as a battery voltage, SoC, and a target charging current, and charging device information such as a coolant temperature and a charging current to each machine learning technique.

The vehicle information or charging device information may further include an outdoor temperature. The outdoor temperature may be confirmed through an outdoor temperature sensor provided in the vehicle or battery charging device.

Further, the charging device information may further include a flow rate of coolant provided to the vehicle during battery charging, an inlet side coolant temperature, and an outlet side coolant temperature.

When the vehicle information and the charging device information are collected as described above, a server (e.g., controller, processor, or the like) communicates with the vehicle and the battery charging device to collect the information of the vehicle and the battery charging device. In step S30, after the server estimates the battery temperature of the vehicle, the server transmits a command signal to control a coolant temperature of the battery charging device via communication.

In the present disclosure, information of the vehicle and the battery charging device is collected through direct communication between the vehicle and the battery charging device, and the battery temperature can be estimated accordingly.

When each information of the vehicle and the battery charging device is collected and stored in the server, the information is continuously accumulated. Additionally, when the battery temperature is estimated through machine learning, the accuracy of the battery temperature estimation can be improved based on sufficiently secured data.

In addition, when the battery temperature is estimated by collecting vehicle information and battery charging device information using machine learning in the server, the battery temperature is rapidly derived according to a complex algorithm. As a result, the coolant temperature of the battery charging device can be rapidly adjusted to an optimal temperature at the time of charging the battery.

Accordingly, the minimum and maximum temperatures of the battery can be estimated based on the vehicle information and charging device information in step S30 of estimating the battery temperature.

In other words, since there are limitations in deriving an accurate battery temperature even when the battery temperature is estimated using the information through machine learning, the lowest temperature in a battery temperature range derived through machine learning is set to the minimum battery temperature and the highest temperature is set to the maximum battery temperature. In particular, in the case of outdoor temperature, the absolute value is more important than the distribution of temperature values. As a result, the battery temperature is normalized to minimum and maximum values.

The battery temperature estimation method may further include the coolant temperature determination step (S40) of determining whether to heat or cool the coolant in the battery charging device based on data regarding the minimum and maximum temperatures of the battery and SoC derived in step S30 of estimating the battery temperature.

In step S30 of estimating the battery temperature, a current battery temperature and a future battery temperature according to the SoC change caused by the progress of charging are predicted.

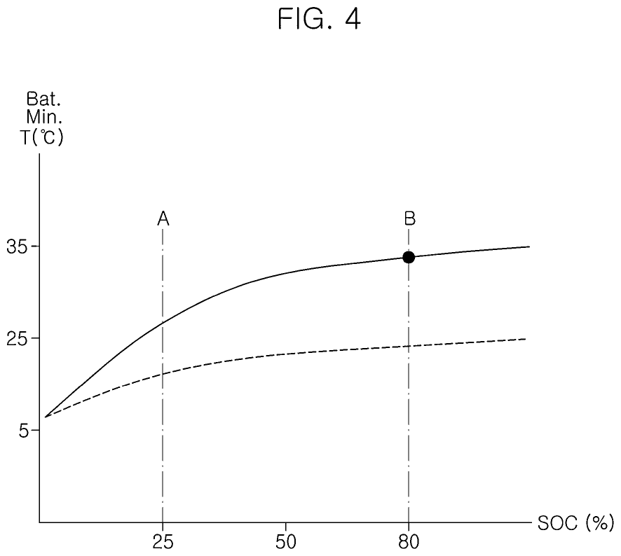

In other words, as can be ascertained from FIG. 4, when the current SoC and the battery temperature are predicted to be “A,” the SoC and the battery temperature are caused to reach a target point “B” by charging the battery at the optimized battery temperature.

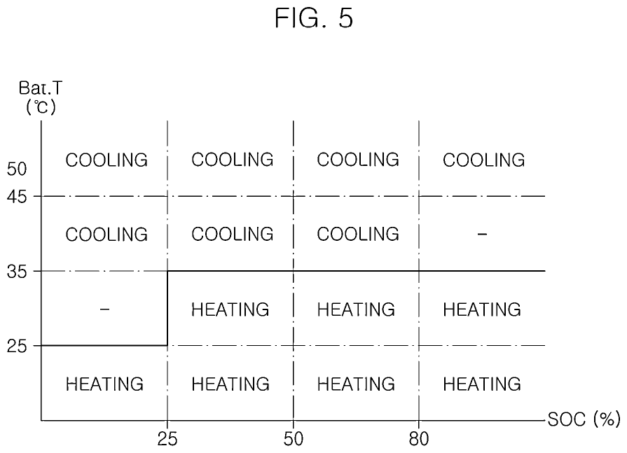

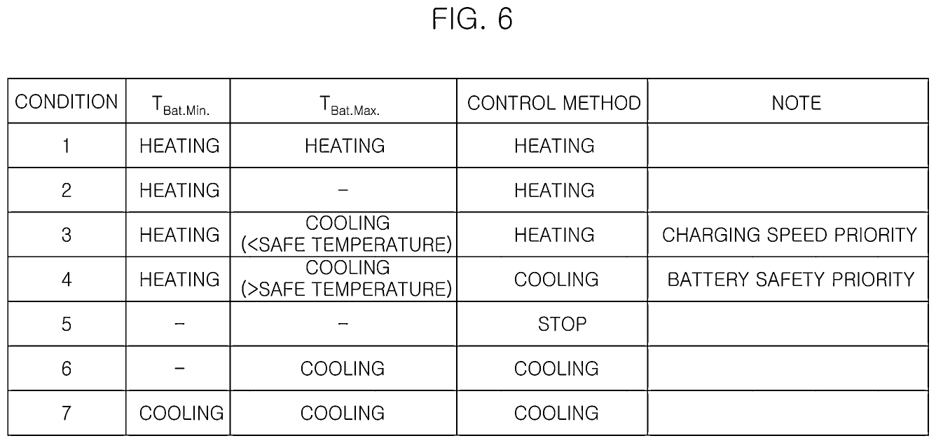

Accordingly, data regarding the minimum and maximum temperatures of the battery and the SoC are stored in advance through experimentation. As an example, this can be represented in the graph shown in FIG. 5 and the table shown in FIG. 6.

As can be seen in FIG. 5, it is possible to ascertain whether the coolant is heated or cooled depending on the temperature and the SoC of the battery. This may be data determined in advance through experimentation according to the specifications and charging specifications of the battery.

Based on this, it is determined whether to heat or cool the coolant depending on whether to heat or cool the coolant at the minimum battery temperature and whether to heat or cool the coolant at the maximum battery temperature, as can be seen in FIG. 6.

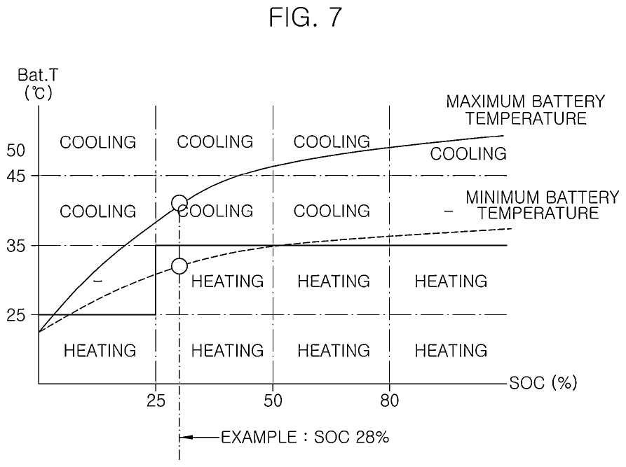

For example, as can be ascertained from FIG. 7, the minimum battery temperature corresponds to heating and the maximum battery temperature corresponds to cooling at an SoC of 28%. As a result, it is possible to determine that the coolant should be heated for optimal temperature management of the battery based on the table shown in FIG. 6.

Accordingly, the coolant can be heated in the battery charging device, and the heated coolant can be supplied to the battery, thereby increasing the temperature of the battery.

In the coolant temperature determination step S40, a set flow rate and a set temperature may be stored in advance according to the determination of heating or cooling the coolant.

In other words, a flow rate and a temperature of the coolant can be set in advance depending on whether the battery is heated or cooled such that the coolant can be provided through the battery charging device to the battery of the vehicle at an optimal flow rate and temperature.

For example, the flow rate of the coolant can be set to 25 liters per minute (LPM) and the temperature of the coolant can be set to 15° C. when cooling the battery is determined. Alternatively, the flow rate of the coolant can be set to 25 LPM and the temperature of the coolant can be set to 60° C. when heating the battery is determined. The flow rate and temperature of the coolant can be optimized and set in various ways depending on the specifications and charging specifications of the battery.

In the coolant temperature determination step S40, when a heating condition is confirmed according to the minimum battery temperature and a cooling condition is confirmed according to the maximum battery temperature, it is possible to determine heating or cooling by comparing the maximum battery temperature and a pre-stored safe temperature.

The safe temperature is a temperature at which the charging performance of the battery deteriorates. When the maximum battery temperature is higher than the safe temperature, the charging efficiency of the battery deteriorates. However, if the battery temperature is lower than the safe temperature, the maximum battery temperature and the safe temperature are compared to determine whether to heat or cool the battery when battery charging efficiency is secured.

In other words, in the coolant temperature determination step S40, it is determined that the coolant is heated when the maximum battery temperature is lower than the safe temperature.

When the maximum battery temperature is lower than the safe temperature, battery charging efficiency has been secured, and thus the temperature of the coolant is increased such that the battery can be heated, thereby maintaining battery charging efficiency. This serves to preferentially control the charging speed of the battery, and even when the maximum battery temperature is determined to be decreased, battery charging efficiency is secured by further comparing the maximum battery temperature and the safe temperature to maintain the heating of the battery.

Additionally, in the coolant temperature determination step S40, it is determined that the coolant is cooled when the maximum battery temperature is higher than the safe temperature.

When the maximum battery temperature is higher than the safe temperature, charging battery efficiency decreases, and thus the battery may be damaged.

Accordingly, if the maximum battery temperature is higher than the safe temperature, cooled coolant is provided to the battery to stabilize the temperature of the battery such that damage to the battery can be prevented.

In step S30 of estimating the battery temperature, a predicted temperature, which is a battery temperature when the SoC is a set SoC, is further estimated based on the vehicle information and the charging device information. The set SoC can be set to 80% as an SoC at which battery charging efficiency decreases, and may be set to various values depending on the specifications of the battery. The predicted temperature is a battery temperature predicted when the SoC is the set SoC and can be derived through machine learning based on vehicle information and battery charging device information.

Additionally, in the coolant temperature determination step S40, when an SoC derived in advance is the set SoC, a maximum set temperature is compared with the predicted temperature to determine whether the coolant is overcooled or overheated.

The maximum set temperature is a battery temperature at which battery efficiency is secured when the SoC is the set SoC and can be derived and stored through experimentation in advance.

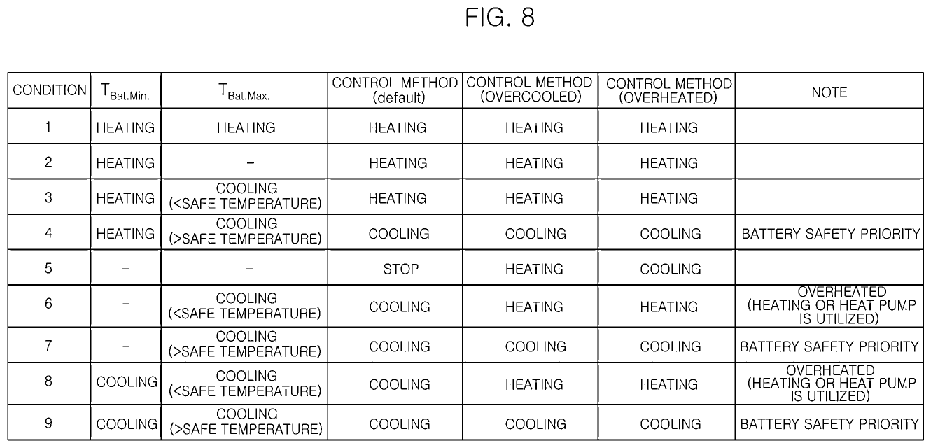

Accordingly, as shown in FIG. 8, the predicted temperature and the maximum set temperature are compared, and when the predicted temperature is lower than the maximum set temperature, it is determined that the coolant is overcooled. In this case, it is determined to increase the temperature of the coolant.

In other words, when the predicted temperature is lower than the maximum set temperature, it is determined that the battery may be overcooled as the temperature of the battery is lowered according to the supply of the coolant during battery charging. Accordingly, the temperature e of the coolant supplied from the battery charging device is increased to prevent overcooling of the battery when the SoC reaches the set SoC.

In the coolant temperature determination step S40, when the heating condition is confirmed according to the current minimum battery temperature, the coolant is heated even when it is determined that the battery is overcooled.

In other words, in a case where the minimum battery temperature corresponds to the heating condition, the current battery temperature is a low temperature at which charging efficiency is reduced, and thus the heated coolant is supplied to the battery to secure battery charging efficiency when the battery is determined to be overcooled.

In addition, the in coolant temperature determination step S40, the maximum battery temperature is compared with temperature when it is confirmed that the current maximum battery temperature corresponds to the cooling condition when the battery is determined to be overcooled. Additionally, the coolant is heated when the maximum battery temperature is lower than the preset safe temperature, and the coolant is cooled when the maximum battery temperature is higher than the preset safe temperature.

In other words, even when the battery is determined to be overcooled, when the maximum battery temperature is lower than the safe temperature, the coolant is heated such that a temperature at which battery charging efficiency is optimized is maintained.

Further, if the maximum battery temperature is higher than the safe temperature, the coolant supplied to the battery is cooled to prevent overheating of the battery.

In the coolant temperature determination step S40, if the predicted temperature is higher than the maximum set determined that the battery has temperature, it is overheated, and the coolant is determined to be cooled.

In other words, when the predicted temperature is higher than the maximum set temperature, it is determined that the battery may overheat as the temperature of the battery increases due to the supply of the coolant during battery charging. Accordingly, the coolant supplied from the battery charging device is cooled to prevent overheating when the SoC reaches the set SoC.

In the coolant temperature determination step S40, when the heating condition is confirmed according to the current minimum battery temperature, the coolant is heated even when it is determined that the battery is overheated.

In other words, when the minimum battery temperature corresponds to the heating condition, the current battery temperature is a low temperature at which charging efficiency is reduced, and thus the heated coolant is supplied to the battery to secure battery charging efficiency when it is determined that the battery is overcooled.

In addition, in the coolant temperature determination step S40, a heat pump or heating is checked when the battery is determined to be overheated. Additionally, the predicted temperature and the preset safe temperature are compared when the heat pump is operated or heating is performed, and the coolant is heated when the predicted temperature is lower than the safe temperature.

This is to operate the heat pump or perform indoor heating using the heat of the battery. Accordingly, when the heat pump is operated or indoor heating is performed, when the maximum battery temperature is lower than the safe temperature even when it is determined that the battery has overheated, the heat pump or indoor heating is implemented using the heat of the battery, and the heated coolant is provided such that the temperature at which battery charging efficiency is optimized is maintained.

According to the above-mentioned control logic, the temperature of the battery and the temperature of the coolant managed in the battery charging device can be controlled according to the table shown in FIG. 8.

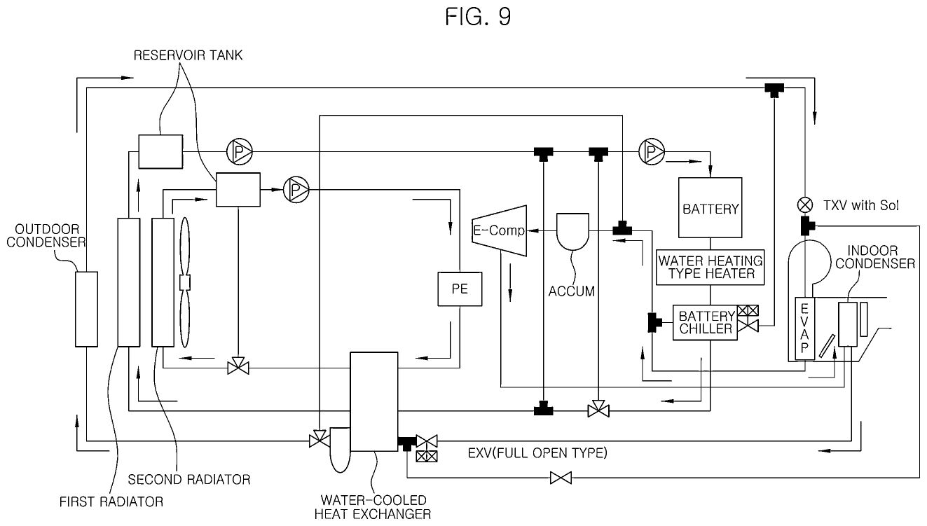

In addition, referring to the circuit diagram shown in FIG. 9, when the battery has overcooled, a first radiator, the overcooled battery, and a second radiator may be used for air conditioning condensing. Additionally, when the temperature of outdoor air is high, the heat of the battery can also be dissipated in the outdoor condenser and thus sufficient heat dissipation can be achieved.

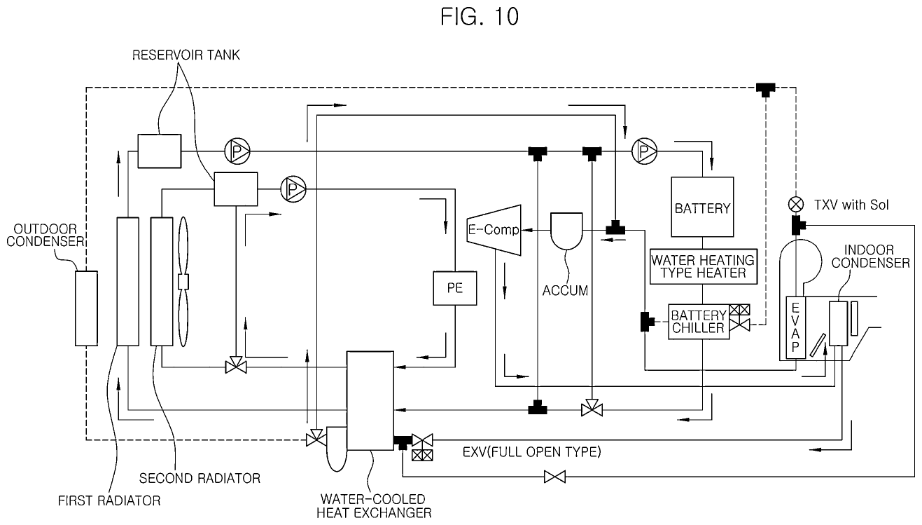

In addition, referring to the circuit diagram shown in FIG. 10, when the battery overheats, the heat source of the battery and the waste heat of power electronics (PE) can be used instead of outside air for the heat pump or heating, and the waste heat of the battery is used regardless of the temperature of the outside air. As a result, a sufficient heat source is secured to achieve heat pump performance and heating efficiency.

In this way, coolant temperature in the determination step S40, the coolant may be cooled when the current battery temperature is higher than the preset safe temperature when the SoC is less than the set SoC.

In addition, in the coolant temperature determination step S40, coolant temperature control is cancelled when the current battery temperature is higher than the preset safe temperature when the SoC is equal to or greater than the set SoC, or when the current battery temperature is close to the preset maximum set temperature.

In other words, when the SoC is equal to or greater than the set SoC, the battery charge is secured, and the charging efficiency is reduced. If the current battery temperature is higher than the safe temperature, coolant temperature control is cancelled. In this way, by cancelling coolant temperature control, the temperature of the battery is maintained at the current state, thereby reducing energy consumption for securing battery charging efficiency.

In addition, the maximum set temperature is the temperature when the pre-derived SoC is the set SoC, and when the current battery temperature is close to the maximum set temperature, the temperature of the battery is determined to be stabilized and coolant temperature control is cancelled.

As described above, the present disclosure provides a battery temperature estimation method based on sharing coolant between a vehicle and a battery charging device 200 during battery charging. The method includes, at step S10, collecting vehicle information including a battery voltage, a state of charge (SoC), and a target charging current from the vehicle. The method also includes: at step S20, collecting charging device information including a coolant temperature and a charging current in the battery charging device 200; at step S30, estimating minimum and maximum temperatures of a battery through machine learning based on the vehicle information and the charging device information; and at step S40, determining whether to heat or cool the coolant in the battery charging device 200 based on data regarding the minimum and maximum temperatures and SoC of the battery.

In addition, the battery temperature estimation system according to the present disclosure includes a vehicle controller 10 that is provided in a vehicle and collects vehicle information including a battery voltage, an SoC, and a target charging current. The system also includes a charging device controller 20 that is provided in the battery charging device 200. The charging device controller 20 is configured to: collect charging device information including a coolant temperature and a charging current in the battery charging device; estimate minimum and maximum temperatures of a battery through machine learning based on the vehicle information and the charging device information; and determine to heat or cool coolant based on data regarding the minimum and maximum temperatures and SoC of the battery.

In other words, in the present disclosure, the temperature of the battery can be derived by applying the battery voltage, SoC, and target charging current, which are vehicle information, and the coolant temperature and charging current, which are charging device information, to machine learning.

The vehicle controller 10 may further collect information on the outdoor temperature through an outdoor temperature sensor.

Additionally, the charging device information collected by the charging device controller 20 may further include a flow rate of coolant provided to the vehicle during battery charging, an inlet side coolant temperature, and an outlet side coolant temperature.

In this way, the vehicle controller 10 and the charging device controller 20 can communicate with each other or share information through an electrical connection. The charging device controller 20 may be configured to estimate a battery temperature based on the information and adjust the coolant temperature of the battery charging device 200.

Accordingly, the present disclosure improves charging efficiency through management of the temperature of a high-voltage battery provided in an electric vehicle during the charging of the high-voltage battery. This is achieved by sharing coolant that is either cooled or heated with coolant managed through the battery charging device 200 disposed outside the vehicle for thermal management of the high-voltage battery to the high-voltage battery of the vehicle 100.

In addition, a current battery temperature and a are estimated based on future battery temperature information of the battery charging device 200 and information of the vehicle 100. The temperature of the coolant is optimized at the time of charging the battery of the vehicle 100 using the battery charging device 200. As a result, charging efficiency and energy efficiency is improved.

According to the battery temperature estimation method and system having the above-described configurations, it is possible to improve charging efficiency through management of the temperature of a high-voltage battery provided in an electric vehicle at the time of charging the high-voltage battery. This is achieved by sharing coolant that is either heated or cooled with coolant managed through a battery charging device outside the electric vehicle for thermal management of the high-voltage battery to the high-voltage battery.

Furthermore, it is possible to estimate a current battery temperature and a future battery temperature based on information on the battery charging device and vehicle information to optimize the temperature of coolant when a vehicle battery is charged using the battery charging device. As a result, charging efficiency and energy efficiency is improved.

Although the present disclosure has been illustrated and described in relation to specific embodiments, it should be apparent to those having ordinary skill in the art that the present disclosure may be modified and changed in various ways without departing from the technical spirit of the present disclosure as provided by the following claims.

What is claimed is:

1. A method of estimating a battery temperature based on shared coolant between a vehicle and a battery charging device during battery charging, the method comprising:
collecting vehicle information including a voltage, a state of charge (SoC), and a target charging current of a battery of the vehicle;
collecting charging device information including a coolant temperature and a charging current in the battery charging device; and
estimating a battery temperature of the vehicle through machine learning based on the vehicle information and the charging device information.

2. The method of claim 1, wherein estimating the battery temperature comprises:
collecting information on the vehicle and the battery charging device by communication with a server; and
when the battery temperature of the vehicle is estimated by the server, transmitting, by the server, a command signal such that a coolant temperature of the battery charging device is controlled accordingly.

3. The method of claim 1, wherein collecting the vehicle information or collecting the charging device information comprises collecting information on an outside temperature.

4. The method of claim 1, wherein collecting the charging device information comprises collecting a flow rate of coolant provided to the vehicle, an inlet side coolant temperature, and an outlet side coolant temperature during battery charging.

5. The method of claim 1, wherein estimating the battery temperature further comprises estimating minimum and maximum temperatures of the battery based on the vehicle information and the charging device information.

6. The method of claim 5, further comprising:
determining a coolant temperature by determining whether to heat or cool the coolant in the battery charging device based on data regarding the minimum and maximum temperatures and the SoC of the battery derived in the estimating of the battery temperature.

7. The method of claim 6, wherein determining the coolant temperature further comprises storing, in advance, a set flow rate and a set temperature according to determination of heating or cooling of the coolant.

8. The method of claim 6, wherein determining the coolant temperature further comprises:
comparing the maximum temperature of the battery with a pre-stored safe temperature; and
determining whether to heat or cool the coolant when a heating condition is confirmed according to the minimum temperature of the battery and a cooling condition is confirmed based on the maximum temperature of the battery.

9. The method of claim 8, wherein determining the coolant temperature further comprises determining to heat the coolant when the maximum temperature of the battery is lower than the pre-stored safe temperature.

10. The method of claim 8, wherein determining the coolant temperature further comprises determining to cool the coolant when the maximum temperature of the battery is higher than the pre-stored safe temperature.

11. The method of claim 6, wherein estimating the battery temperature further comprises estimating a predicted temperature corresponding to a battery temperature when the SoC is a set SoC based on the vehicle information and the charging device information, and
wherein determining the coolant temperature further comprises determining whether the battery is overcooled or overheated by comparing a maximum set temperature when a pre-derived SoC is the set SoC at the predicted temperature.

12. The method of claim 11, wherein determining the coolant temperature further comprises:
determining that the battery is overcooled when the predicted temperature is lower than the maximum set temperature; and
determining to heat the coolant upon determining that the battery is overcooled.

13. The method of claim 12, wherein determining the coolant temperature further comprises determining to heat the coolant when the battery is determined to be overcooled and a heating condition is confirmed based on a current minimum battery temperature.

14. The method of claim 12, wherein determining the coolant temperature further comprises:
comparing the maximum temperature of the battery with a preset safe temperature when a current maximum battery temperature is determined to correspond to a cooling condition when the battery is determined to be overcooled;
heating the coolant when the maximum temperature of the battery is lower than the preset safe temperature; and
cooling the coolant when the maximum temperature of the battery is higher than the preset safe temperature.

15. The method of claim 11, wherein determining the coolant temperature further comprises:
determining that the battery is overheated when the predicted temperature is than the maximum set higher temperature; and
cooling the coolant upon determining that the battery is overheated.

16. The method of claim 15, wherein determining the coolant temperature further comprises determining to heat the coolant when the battery is determined to be overheated and a heating condition is confirmed based on a current minimum battery temperature.

17. The method of claim 15, wherein determining the coolant temperature further comprises:
checking whether a heat pump or heating is used when the battery is determined to be overheated;
comparing the predicted temperature with a preset safe temperature when the heat pump operates or heating is performed; and
determining to heat the coolant when the predicted temperature is lower than the safe temperature.

18. The method of claim 6, wherein determining the coolant temperature further comprises determining to cool the coolant when a current battery temperature is higher than a preset safe temperature when the SoC is less than a set SoC.

19. The method of claim 6, wherein determining the coolant temperature further comprises cancelling coolant temperature control when a current battery temperature is higher than a preset safe temperature and the SoC is higher than or equal to a set SoC, or when the current battery temperature is close to a preset maximum set temperature.

20. A method of estimating a battery temperature based on shared coolant between a vehicle and a battery charging device during battery charging, the method comprising:
collecting vehicle information including a voltage, a state of charge (SoC), and a target charging current of a battery of the vehicle;
collecting charging device information including a coolant temperature and a charging current in the battery charging device;
estimating minimum and maximum temperatures of the battery through machine learning based on the vehicle information and the charging device information; and
determining whether to heat or cool the coolant in the battery charging device based on data regarding the minimum and maximum temperatures and SoC of the battery.

21. A system for estimating a battery temperature, the system comprising:
a vehicle controller provided in a vehicle and configured to collect vehicle information including a voltage, a state of charge (SoC), and a target charging current of a battery of the vehicle; and
a charging device controller provided in a battery charging device and configured:
to collect charging device information including a coolant temperature and a charging current in the battery charging device,
to estimate minimum and maximum temperatures of the battery through machine learning g based on the vehicle information and the charging device information, and
to determine whether to heat or cool coolant based on data regarding the minimum and maximum temperatures and SoC of the battery.
